(19) United States
(12) Patent Application Publication
(10) Pub. No.: US 2018/0253676 A1
(43) Pub. Date: Sep. 6, 2018

(54) AUTOMATIC ANALYSIS OF A TECHNICAL CAPABILITY

(71) Applicant: Accenture Global Solutions Limited, Dublin (IE)

(72) Inventors: Mallory SHETH, San Diego, CA (US); Elliot Brook, Los Angeles, CA (US); Robert E. Berkey, Beaverton, OR (US); Scott Alister, Naperville, IL (US); Chad Vaske, Minneapolis, MN (US); Powell Jones, Roswell, GA (US); Antonio Castro, Brooklyn, NY (US)

(21) Appl. No.: 15/446,605

(22) Filed: Mar. 1, 2017

(51) Int. Cl. G06Q 10/06

(52) U.S. Cl. CPC G06Q 10/06393; G06Q 10/06316; G06Q 10/06315

(57) ABSTRACT

A device may receive multiple data elements related to a technical capability of resources of an organization. The technical capability may be associated with gathering, storing, processing, or providing data. The multiple data elements may be received from a hardware resource of the organization. The device may store the multiple data elements in a storage device associated with a cloud computing environment. The storage device may store multiple other data elements associated with another organization. The device may perform an analysis of the multiple data elements to identify a deficiency related to the technical capability of resources of the organization. The device may generate multiple action items to perform based on identifying the deficiency, where the multiple action items are to reduce the deficiency. The device may perform an action associated with the multiple action items to positively impact the deficiency.

### BACKGROUND

An organization may have various technical capabilities. For example, the organization may have an analytics capability, a data processing capability, a data storage capability, a data mining capability, a big data capability, and/or the like. In this case, the technical capabilities of one organization may differ from that of another organization.

### SUMMARY

According to some possible implementations, a device may include one or more processors to receive multiple data elements related to a technical capability of resources of an organization. The technical capability may be associated with gathering, storing, processing, or providing data. The multiple data elements may include at least one qualitative data element. The one or more processors may store the multiple data elements in one or more storage devices associated with the device. The one or more processors may identify a deficiency related to the technical capability of resources of the organization based on analyzing the multiple data elements. The deficiency may negatively impact the technical capability of resources of the organization. The deficiency may be identified via a quantitative determination with respect to threshold data. The one or more processors may generate an output that indicates a first priority related to the deficiency based on identifying the deficiency. The one or more processors may generate multiple action items to perform based on the output, where the multiple action items are to positively impact the deficiency. The one or more processors may perform an action associated with the multiple action items based on generating the multiple action items, where the action is to positively impact the deficiency in a quantitative manner with respect to the threshold data.

According to some possible implementations, a method may include receiving, by a device, a plurality of data elements related to a technical capability of resources of an organization. The technical capability may include an analytics capability, a data processing capability, or a big data capability. The method may include storing, by the device, the plurality of data elements in one or more storage devices associated with the device. The method may include performing, by the device, an analysis of the plurality of data elements to identify a deficiency related to the technical capability of resources of the organization. The deficiency may negatively impact the technical capability of resources of the organization. The method may include generating, by the device, a plurality of action items to perform based on identifying the deficiency, where the plurality of action items are to positively impact the deficiency. The plurality of action items may be based on the deficiency. The method may include performing, by the device, an action associated with the plurality of action items to positively impact the deficiency.

According to some possible implementations, a non-transitory computer-readable medium may store one or more instructions that, when executed by one or more processors of one or more computing devices of a cloud computing environment, cause the one or more processors to receive multiple data elements related to a technical capability of resources of an organization. The technical capability may be associated with gathering, storing, processing, or providing data. The multiple data elements may be received from one or more hardware resources of the organization. The one or more instructions, when executed by the one or more processors, may cause the one or more processors to store the multiple data elements in one or more storage devices associated with the cloud computing environment. The one or more storage devices may store multiple other data elements associated with one or more other organizations. The one or more instructions, when executed by the one or more processors, may cause the one or more processors to perform an analysis of the multiple data elements to identify a deficiency related to the technical capability of resources of the organization. The one or more instructions, when executed by the one or more processors, may cause the one or more processors to generate multiple action items to perform based on identifying the deficiency, where the multiple action items are to reduce the deficiency. The one or more instructions, when executed by the one or more processors, may cause the one or more processors to perform an action associated with the multiple action items to positively impact the deficiency.

### BRIEF DESCRIPTION OF THE DRAWINGS

FIGS. 1A-1C are diagrams of an overview of an example implementation described herein;

FIG. 2 is a diagram of an example environment in which systems and/or methods, described herein, may be implemented;

FIG. 3 is a diagram of example components of one or more devices of FIG. 2;

FIG. 4 is a flow chart of an example process for automatic analysis of a technical capability; and

FIGS. 5A-5D are diagrams of an example implementation relating to the example process shown in FIG. 4.

### DETAILED DESCRIPTION

The following detailed description of example implementations refers to the accompanying drawings. The same reference numbers in different drawings may identify the same or similar elements.

An organization may want to analyze (e.g., assess) a state of a technical capability of resources of the organization (e.g., thousands, millions, or billions of resources). For example, the organization may want to assess versions of software used by the organization relative to current market offerings, processing and/or storage capabilities of resources of the organization relative to other organizations, hardware used by the organization to implement a process, processes of the organization related to gathering and/or analyzing data, and/or the like. However, the organization may lack a technique for analyzing a state of a technical capability of resources of the organization.

Implementations described herein enable a capability diagnostic platform to gather and analyze data related to a technical capability of resources of an organization. In addition, the implementations described herein permit the capability diagnostic platform to make objective, or quantitative, determinations with respect to a technical capability of an organization based on subjective or qualitative inputs using adaptive (e.g., dynamic or changing) data. In this way, the capability diagnostic platform enables identification of a deficiency related to the technical capability, and/or enables facilitation of fixing the deficiency, thereby improving a technical capability of resources of the organization. Furthermore, in this way, the capability diagnostic platform improves processing and/or computing resources of the organization, thereby improving an efficiency of operations of the organization. Furthermore, in this way, the capability diagnostic platform enables quick and efficient analysis of a technical capability of resources of an organization, thereby conserving processing and/or computing resources.

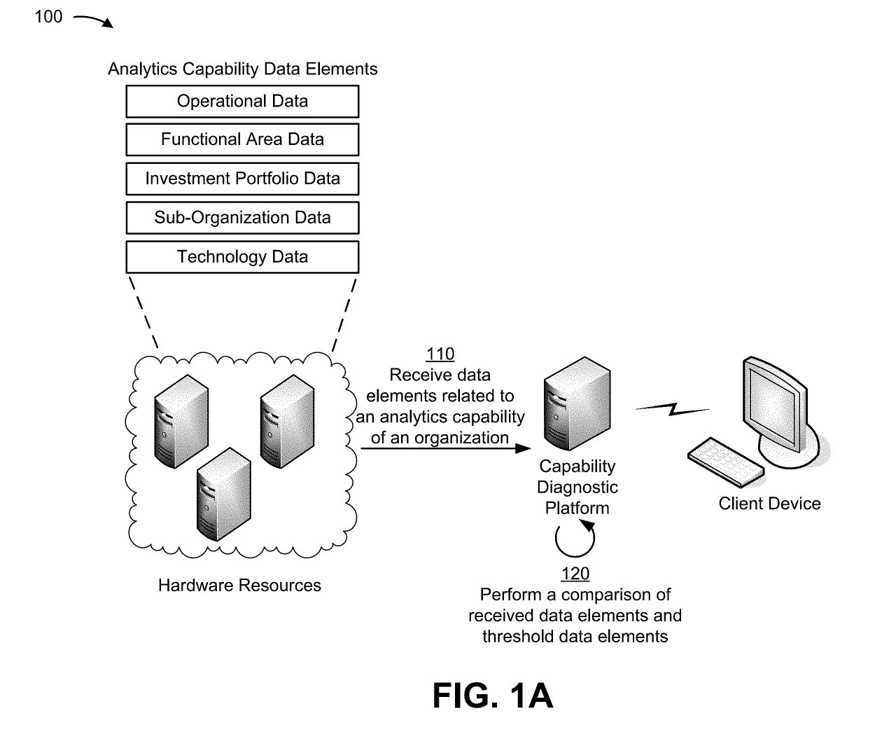

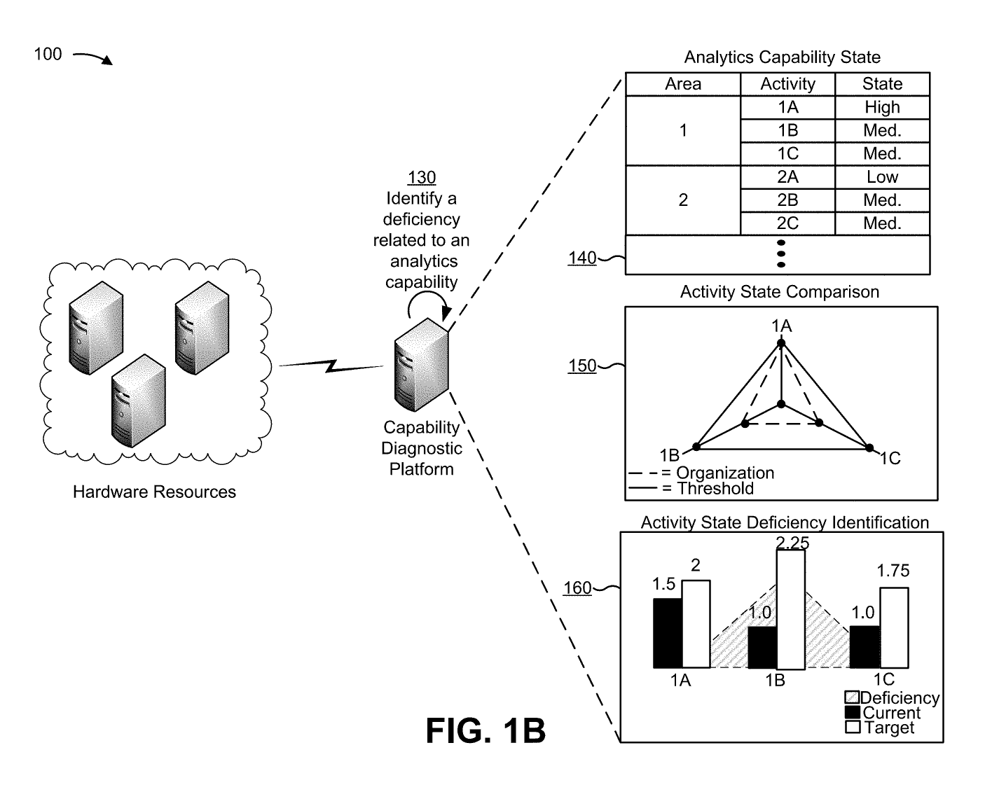

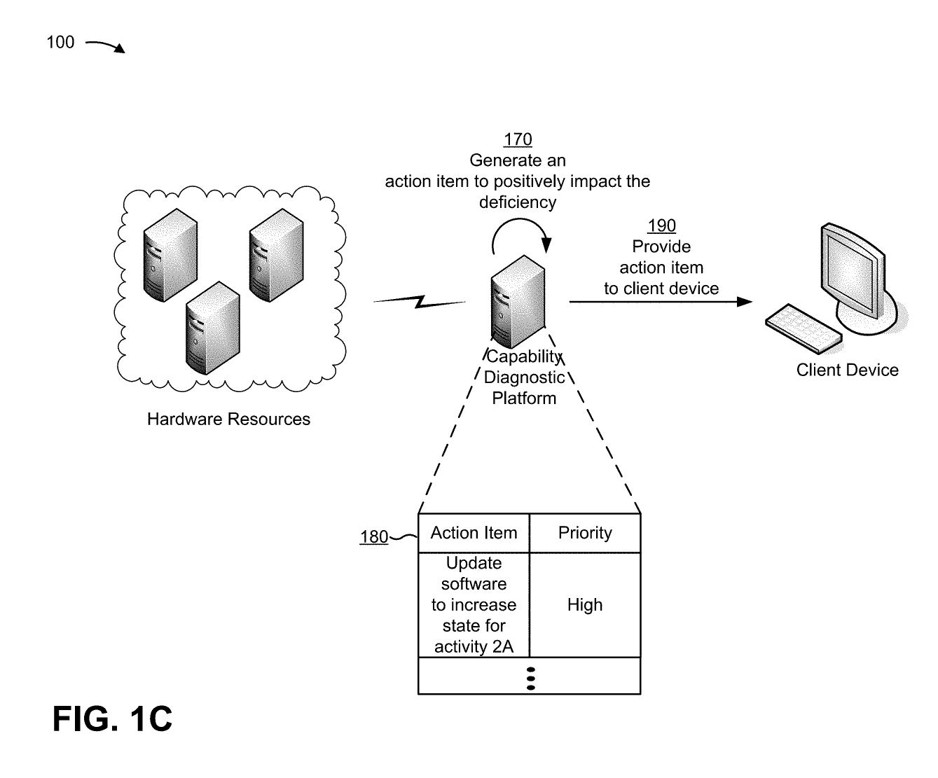

FIGS. 1A-1C are diagrams of an overview of an example implementation 100 described herein. As shown in FIG. 1A, example implementation 100 may include a group of hardware resources, a capability diagnostic platform, and a client device. As shown by reference number 110, the capability diagnostic platform may receive data elements related to an analytics capability of resources of an organization. In some implementations, the capability diagnostic platform may receive the data elements from the group of hardware resources.

As one example, the data elements may include operational data (e.g., data related to operations and/or an operating model of the organization related to analytics). As another example, the data elements may include functional area data (e.g., data related to a functional area of the organization that is related to analytics or performs analytics, such as a marketing functional area, a supply chain functional area, a finance functional area, etc.). As another example, the data elements may include investment portfolio data (e.g., data related to investment in an analytics capability). As another example, the data elements may include sub-organization data (e.g., data related to an analytics capability of resources of a sub-organization of the organization, such as data related to performing analytics from across various departments of the organization). As another example, the data elements may include technology data (e.g., data related to technology used in association with the analytics capability, data quality/governance processes, types of data to which an organization has access, data preparation/cleansing processes, etc.).

In some implementations, the capability diagnostic platform may receive the data elements from electronic records used to store the data elements. In some implementations, the capability diagnostic platform may receive the data elements based on processing text (e.g., documentation, a web page, a transcript of an interview, etc.) using natural language processing, machine learning, artificial intelligence, computational linguistics, and/or the like. In some implementations, the capability diagnostic platform may receive the data elements in the form of survey data (e.g., where people, associated with the organization, rate aspects of the analytics capability on a scale). In some implementations, the capability diagnostic platform may receive the data elements as a result of performing tests on and/or performing an analysis of resources associated with the organization.

As shown by reference number 120, the capability diagnostic platform may perform a comparison of received data elements and threshold data elements. For example, the capability diagnostic platform may base the threshold data elements on data from other organizations (e.g., where data from different organizations has been normalized and analyzed to determine an industry standard), on data that identifies industry standards or best practices, on pre-defined thresholds, and/or the like. The capability diagnostic platform may determine whether the received data elements satisfy the threshold data elements. In addition, the capability diagnostic platform may perform a calculation (e.g., generate a score) when analyzing a technical capability to identify a software and/or hardware solution to positively impact the technical capability.

In some implementations, the capability diagnostic platform may identify an industry of the organization (e.g., based on input from a user, information identifying the types of resources used by the organization, information stored by a resource of the organization that identifies the industry, etc.). The capability diagnostic platform may identify data associated with other organizations in the same industry (e.g., field) as the organization being analyzed (e.g., anonymized data) after identifying the industry of the organization being analyzed. The capability diagnostic platform may use the data associated with other organizations in the same industry to determine a threshold data element.

As shown in FIG. 1B, and by reference number 130, the capability diagnostic platform may identify a deficiency related to an analytics capability of resources of the organization. For example, the capability diagnostic platform may identify the deficiency by performing the comparison of the received data elements and the threshold data elements. Continuing with the previous example, the capability diagnostic platform may identify a deficiency where the received data elements do not satisfy the threshold data elements, satisfy a first threshold rather than a second threshold, are not within a delta of the threshold data elements, and/or the like.

In some implementations, the capability diagnostic platform may generate various reports that identify a current state (e.g., deficiency) of the analytics capability of resources of the organization. For example, and as shown by reference number 140, the capability diagnostic platform may generate a report related to a state of the analytics capability. In this case, a state of an analytics capability may be relative to other organizations, an industry standard, a desired state, a threshold state, a particular state of technical capabilities, and/or the like. As another example, and as shown by reference number 150, the capability diagnostic platform may generate a report that compares a state of the organization to a threshold. As another example, and as shown by reference number 160, the capability diagnostic platform may generate a report that identifies deficiencies between a current state of an analytics capability and a target state (e.g., threshold).

As shown in FIG. 1C, and by reference number 170, the capability diagnostic platform may generate an action item to positively impact the deficiency. For example, the capability diagnostic platform may generate the action item based on a result of the comparison, based on a report generated, based on an action item generated for another organization (e.g., with a similar deficiency) that positively impacted the deficiency, and/or the like.

As shown by reference number 180, and for example, the capability diagnostic platform may generate an action item to update software to increase a state for activity 2A of an analytics capability (e.g., increase the state from low to high). As further shown by reference number 180, the capability diagnostic platform may determine a priority for a generated action item. In some implementations, the capability diagnostic platform may generate a score for the action item to determine the priority. For example, the capability diagnostic platform may base the score on a change in state relative to another action item, cost of the action item, time needed to complete the action item, and/or the like. Additionally, or alternatively, a report generated by the capability diagnostic platform (e.g., shown by reference numbers 140, 150, and 160) may identify a priority for deficiencies identified. For example, the report may be color coded, such that different colors indicate different severities of various deficiencies.

As shown by reference number 190, the capability diagnostic platform may provide the action item to a client device (e.g., to cause the action item to be acted upon by the client device). In this case, the capability diagnostic platform may perform an action to implement the action item. For example, the capability diagnostic platform may obtain and push software updates to client devices used by people associated with the organization.

In this way, a capability diagnostic platform enables identification of a deficiency related to a technical capability, and/or enables facilitation of fixing the deficiency, thereby improving the technical capability of resources of the organization. Furthermore, in this way, the capability diagnostic platform improves processing and/or computing resources of the organization, thereby improving an efficiency of operations of the organization. Furthermore, in this way, the capability diagnostic platform enables quick and efficient analysis of a technical capability of resources of an organization, thereby conserving processing and/or computing resources.

As indicated above, FIGS. 1A-1C are provided merely as an example. Other examples are possible and may differ from what was described with regard to FIGS. 1A-1C. For example, although FIGS. 1A-1C are described with respect to an analytics capability, other examples may relate to other technical capabilities, such as a data processing capability, a big data capability, and/or the like.

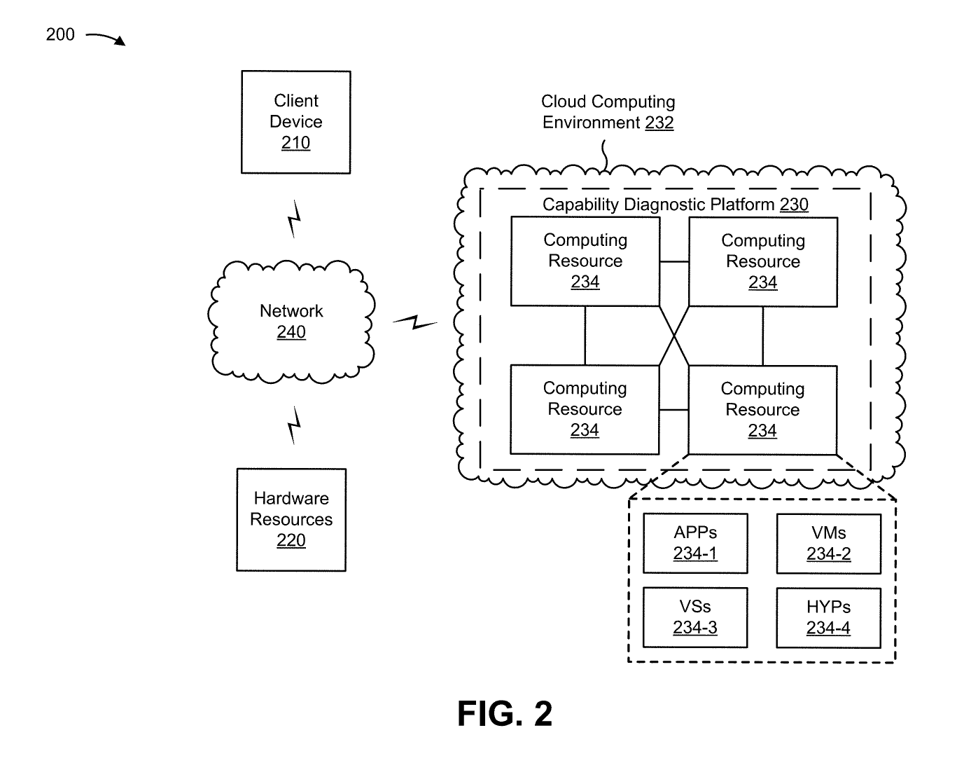

FIG. 2 is a diagram of an example environment 200 in which systems and/or methods, described herein, may be implemented. As shown in FIG. 2, environment 200 may include a client device 210, hardware resources 220, a capability diagnostic platform 230, a cloud computing environment 232, a set of computing resources 234 (hereinafter referred to collectively as “computing resources 215” and individually as “computing resource 215”), and a network 240. Devices of environment 200 may interconnect via wired connections, wireless connections, or a combination of wired and wireless connections.

Client device 210 includes one or more devices capable of receiving, generating, storing, processing, and/or providing information associated with a technical capability of resources of an organization. For example, client device 210 may include a communication and/or computing device, such as a mobile phone (e.g., a smart phone or a radiotelephone), a laptop computer, a desktop computer, a tablet computer, a gaming device, a wearable communication device (e.g., a smart wristwatch or a pair of smart eyeglasses), or a similar type of device. In some implementations, client device 210 may provide information related to a technical capability of resources of an organization to capability diagnostic platform 230, as described elsewhere herein. Additionally, or alternatively, capability diagnostic platform 230 may receive information related to a deficiency identified by capability diagnostic platform 230 and/or an action item generated by capability diagnostic platform 230, as described elsewhere herein.

Hardware resources 220 include one or more devices capable of receiving, providing, storing, generating, and/or processing information associated with a technical capability of resources of an organization. For example, hardware resources 220 may include a server (e.g., in a data center or a cloud computing environment), a data center (e.g., a multi-server micro data center), a workstation computer, a virtual machine (VM) provided in a cloud computing environment, a user device, or a similar type of device. In some implementations, hardware resources 220 may provide information related to a technical capability of resources of an organization (e.g., physical resources, data resources, or human resources), as described elsewhere herein. Additionally, or alternatively, hardware resources 220 may store a result of analyzing information related to a technical capability of a resource of the organization, as described elsewhere herein.

Capability diagnostic platform 230 includes one or more devices capable of analyzing technical capabilities of resources of an organization. For example, capability diagnostic platform 230 may include a cloud server or a group of cloud servers. In some implementations, capability diagnostic platform 230 may be designed to be modular such that certain software components can be swapped in or out depending on a particular need. As such, capability diagnostic platform 230 may be easily and/or quickly reconfigured for different uses.

In some implementations, as shown, capability diagnostic platform 230 may be hosted in cloud computing environment 232. Notably, while implementations described herein describe capability diagnostic platform 230 as being hosted in cloud computing environment 232, in some implementations, capability diagnostic platform 230 may not be cloud-based (i.e., may be implemented outside of a cloud computing environment) or may be partially cloud-based.

Cloud computing environment 232 includes an environment that hosts capability diagnostic platform 230. Cloud computing environment 232 may provide computation, software, data access, storage, etc. services that do not require end-user (e.g., client device 210) knowledge of a physical location and configuration of system(s) and/or device(s) that host capability diagnostic platform 230. As shown, cloud computing environment 232 may include a group of computing resources 234 (referred to collectively as “computing resources 234” and individually as “computing resource 234”).

Computing resource 234 includes one or more personal computers, workstation computers, hardware resources, or other types of computation and/or communication devices. In some implementations, computing resource 234 may host capability diagnostic platform 230. The cloud resources may include compute instances executing in computing resource 234, storage devices provided in computing resource 234, data transfer devices provided by computing resource 234, etc. In some implementations, computing resource 234 may communicate with other computing resources 234 via wired connections, wireless connections, or a combination of wired and wireless connections.

As further shown in FIG. 2, computing resource 234 may include a group of cloud resources, such as one or more applications (“APPs”) 234-1, one or more virtual machines (“VMs”) 234-2, one or more virtualized storages (“VSs”) 234-3, or one or more hypervisors (“HYPs”) 234-4.

Application 234-1 includes one or more software applications that may be provided to or accessed by one or more devices of environment 200. Application 234-1 may eliminate a need to install and execute the software applications on devices of environment 200. For example, application 234-1 may include software associated with capability diagnostic platform 230 and/or any other software capable of being provided via cloud computing environment 232. In some implementations, one application 234-1 may send/receive information to/from one or more other applications 234-1, via virtual machine 234-2.

Virtual machine 234-2 includes a software implementation of a machine (e.g., a computer) that executes programs like a physical machine. Virtual machine 234-2 may be either a system virtual machine or a process virtual machine, depending upon use and degree of correspondence to any real machine by virtual machine 234-2. A system virtual machine may provide a complete system platform that supports execution of a complete operating system (“OS”). A process virtual machine may execute a single program, and may support a single process. In some implementations, virtual machine 234-2 may execute on behalf of a user (e.g., client device 210), and may manage infrastructure of cloud computing environment 232, such as data management, synchronization, or long-duration data transfers.

Virtualized storage 234-3 includes one or more storage systems and/or one or more devices that use virtualization techniques within the storage systems or devices of computing resource 234. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

Hypervisor 234-4 may provide hardware virtualization techniques that allow multiple operating systems (e.g., “guest operating systems”) to execute concurrently on a host computer, such as computing resource 234. Hypervisor 234-4 may present a virtual operating platform to the guest operating systems, and may manage the execution of the guest operating systems. Multiple instances of a variety of operating systems may share virtualized hardware resources.

Network 240 includes one or more wired and/or wireless networks. For example, network 240 may include a cellular network (e.g., a long-term evolution (LTE) network, a code division multiple access (CDMA) network, a 3G network, a 4G network, a 5G network, another type of advanced generation network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, or the like, and/or a combination of these or other types of networks.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

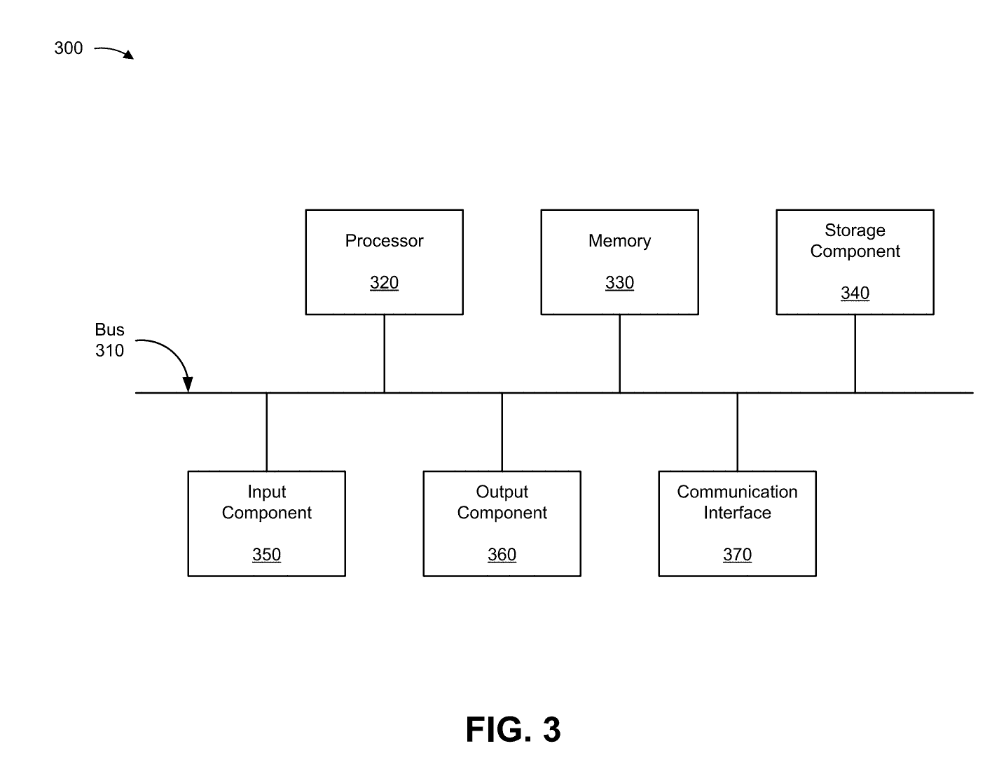

FIG. 3 is a diagram of example components of a device 300. Device 300 may correspond to client device 210, hardware resources 220, capability diagnostic platform 230, and/or computing resource 234. In some implementations, client device 210, hardware resources 220, capability diagnostic platform 230, and/or computing resource 234 may include one or more devices 300 and/or one or more components of device 300. As shown in FIG. 3, device 300 may include a bus 310, a processor 320, a memory 330, a storage component 340, an input component 350, an output component 360, and a communication interface 370.

Bus 310 includes a component that permits communication among the components of device 300. Processor 320 is implemented in hardware, firmware, or a combination of hardware and software. Processor 320 includes a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 320 includes one or more processors capable of being programmed to perform a function. Memory 330 includes a random access memory (RAM), a read only memory (ROM), and/or another type of dynamic or static storage device (e.g., a flash memory, a magnetic memory, and/or an optical memory) that stores information and/or instructions for use by processor 320.

Storage component 340 stores information and/or software related to the operation and use of device 300. For example, storage component 340 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

Input component 350 includes a component that permits device 300 to receive information, such as via user input (e.g., a touch screen display, a keyboard, a keypad, a mouse, a button, a switch, and/or a microphone). Additionally, or alternatively, input component 350 may include a sensor for sensing information (e.g., a global positioning system (GPS) component, an accelerometer, a gyroscope, and/or an actuator). Output component 360 includes a component that provides output information from device 300 (e.g., a display, a speaker, and/or one or more light-emitting diodes (LEDs)).

Communication interface 370 includes a transceiver-like component (e.g., a transceiver and/or a separate receiver and transmitter) that enables device 300 to communicate with other devices, such as via a wired connection, a wireless connection, or a combination of wired and wireless connections. Communication interface 370 may permit device 300 to receive information from another device and/or provide information to another device. For example, communication interface 370 may include an Ethernet interface, an optical interface, a coaxial interface, an infrared interface, a radio frequency (RF) interface, a universal serial bus (USB) interface, a Wi-Fi interface, a cellular network interface, or the like.

Device 300 may perform one or more processes described herein. Device 300 may perform these processes in response to processor 320 executing software instructions stored by a non-transitory computer-readable medium, such as memory 330 and/or storage component 340. A computer-readable medium is defined herein as a non-transitory memory device. A memory device includes memory space within a single physical storage device or memory space spread across multiple physical storage devices.

Software instructions may be read into memory 330 and/or storage component 340 from another computer-readable medium or from another device via communication interface 370. When executed, software instructions stored in memory 330 and/or storage component 340 may cause processor 320 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 3 are provided as an example. In practice, device 300 may include additional components, fewer components, different components, or differently arranged components than those shown in FIG. 3. Additionally, or alternatively, a set of components (e.g., one or more components) of device 300 may perform one or more functions described as being performed by another set of components of device 300.

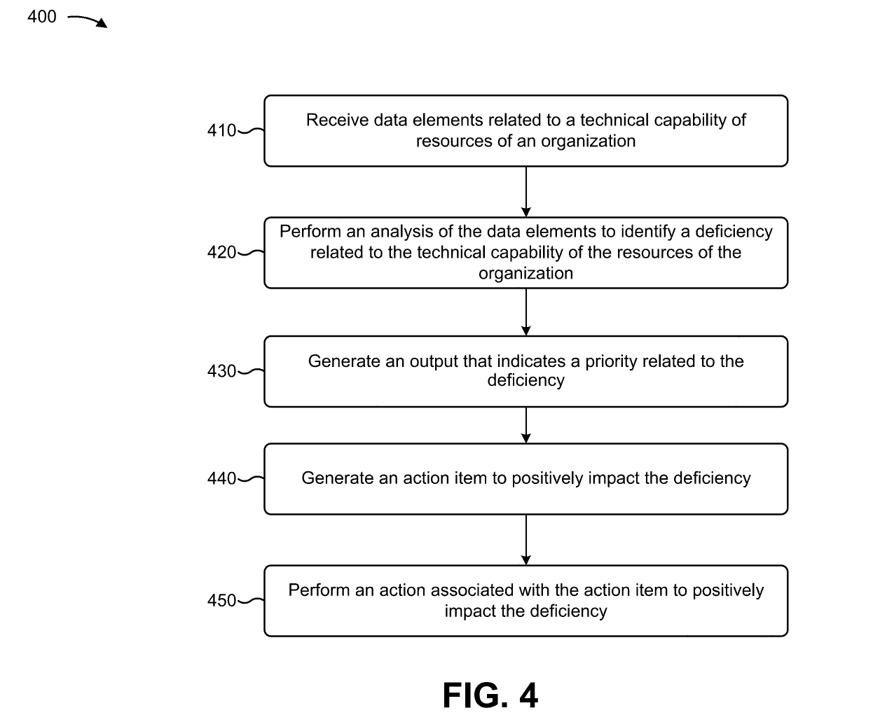

FIG. 4 is a flow chart of an example process 400 for automatic analysis of a technical capability. In some implementations, one or more process blocks of FIG. 4 may be performed by capability diagnostic platform 230. In some implementations, one or more process blocks of FIG. 4 may be performed by another device or a group of devices separate from or including capability diagnostic platform 230 such as client device 210 and hardware resources 220.

As shown in FIG. 4, process 400 may include receiving data elements related to a technical capability of resources of an organization (block 410). For example, capability diagnostic platform 230 may receive data elements, from hardware resources 220, related to a technical capability of resources of an organization. In some implementations, resources of an organization may include physical resources (e.g., hardware resources 220, desktop computers, servers, tablets, smartphones, etc. used by the organization), data resources (e.g., different types of data owned by the organization), human resources (e.g., people working for the organization), and/or the like. In some implementations, an organization may include a business, such as a private organization, a government organization, and/or the like.

In some implementations, capability diagnostic platform 230 may receive millions or billions of data elements associated with one or more organizations. For example, a data element may include a value for a property of a technical capability of a resource of an organization at a particular time. In some implementations, capability diagnostic platform 230 may receive the data elements from hardware resources 220 (e.g., periodically, according to a schedule, based on requesting the data element, based on an event occurring, etc.).

In some implementations, capability diagnostic platform 230 may receive at least some of the data elements based on processing text. For example, text may include a text document, a web page, a transcript of an interview, audio converted to text (e.g., using automatic speech recognition (ASR), computer speech recognition, speech-to-text, etc.), and/or the like. In some implementations, capability diagnostic platform 230 may process the text using natural language processing, text analysis, computational linguistics, artificial intelligence, machine learning, and/or the like. For example, capability diagnostic platform 230 may process the text to identify a term and/or tag included in the text, a set of characters, such as a single character, multiple characters (e.g., a character string), a combination of characters that form multiple words (e.g., a multi-word term, such as a phrase, a sentence, or a paragraph), a combination of characters that form an acronym, a combination of characters that form an abbreviation of a word, or a combination of characters that form a misspelled word, included in the text.

In some implementations, capability diagnostic platform 230 may process the text using information and/or instructions for identifying a term in the text. For example, capability diagnostic platform 230 may use a tag list that identifies tags (e.g., part-of-speech tags or user-input tags) to be used to identify a term in the text. As another example, capability diagnostic platform 230 may use a term list (e.g., a glossary that identifies terms in the text, a dictionary that includes term definitions, a thesaurus that includes term synonyms or antonyms, or a lexical database, such as WordNet, that identifies a term in the text (e.g., a single-word term and/or a multi-word term)).

In some implementations, when processing the text, capability diagnostic platform 230 may prepare the text for processing. For example, capability diagnostic platform 230 may standardize the text to prepare the text for processing. In some implementations, preparing the text for processing may include adjusting characters, such as by removing characters, replacing characters, adding characters, adjusting a font, adjusting formatting, adjusting spacing, removing white space (e.g., after a beginning quotation mark, before an ending quotation mark, before or after a range indicator, such as a hyphen dash, or a colon, or before or after a punctuation mark, such as a percentage sign). For example, capability diagnostic platform 230 may replace multiple spaces with a single space, may insert a space after a left parenthesis, a left brace, or a left bracket, or may insert a space before a right parenthesis, a right brace, or a right bracket. In this way, capability diagnostic platform 230 may use a space delimiter to more easily parse the text.

In some implementations, capability diagnostic platform 230 may prepare the text for processing by expanding acronyms in the text. For example, capability diagnostic platform 230 may replace a short-form acronym, in text, with a full-form term that the acronym represents (e.g., may replace “EPA” with “Environmental Protection Agency”). Capability diagnostic platform 230 may determine the full-form term of the acronym by, for example, using a glossary or other input text, searching the text for consecutive words with beginning letters that correspond to the acronym (e.g., where the beginning letters “ex” may be represented in an acronym by “X”) to identify a potential full-form term of an acronym, or by searching for potential full-form terms that appear near the acronym in the text (e.g., within a threshold quantity of words).

In some implementations, capability diagnostic platform 230 may prepare the text for processing by replacing characters and/or symbols with one or more terms. For example, capability diagnostic platform 230 may replace an “@” symbol in text with the term “at.” In some implementations, when capability diagnostic platform 230 replaces a character and/or symbol, capability diagnostic platform 230 may add leading and/or trailing spaces. For example, capability diagnostic platform 230 may process the text “@Paris airport” to form the text “at the Paris airport.”

In some implementations, capability diagnostic platform 230 may associate a tag with a word included in the text (e.g., based on a tag association rule). In some implementations, the tag association rule may specify a manner in which the tag is to be associated with a word, or based on characteristics of the word. For example, a tag association rule may specify that a singular noun tag (“/NN”) is to be associated with words that are singular nouns (e.g., based on a language database or a context analysis). In some implementations, a tag may include a part-of-speech (POS) tag, such as NN (noun, singular or mass), NNS (noun, plural), NNP (proper noun, singular), NNPS (proper noun, plural), VB (verb, base form), VBD (verb, past tense), VBG (verb, gerund or present participle), and/or the like.

In some implementations, a word may refer to a unit of language that includes one or more characters. A word may include a dictionary word (e.g., “gas”) or may include a non-dictionary string of characters (e.g., “asg”). In some implementations, a word may be a term. Alternatively, a word may be a subset of a term (e.g., a term may include multiple words). In some implementations, capability diagnostic platform 230 may determine words in the text by determining characters identified by one or more delimiting characters, such as a space, or a punctuation mark (e.g., a comma, a period, an exclamation point, or a question mark).

In some implementations, capability diagnostic platform 230 may generate a list of unique terms based on the tags. For example, the list of unique terms (e.g., a term corpus) may refer to a set of terms (e.g., single word terms or multi-word terms) extracted from the text. In some implementations, the term corpus may include terms tagged with a noun tag and/or a tag derived from a noun tag. Additionally, or alternatively, the term corpus may include terms identified based on input provided by a user (e.g., of client device 210), which may be tagged with a term tag, in some implementations. For example, the input may include input that identifies multi-word terms, input that identifies a pattern for identifying multi-word terms, such as a pattern of consecutive words associated with particular part-of-speech tags, or a pattern of terms appearing at least a threshold quantity of times in the text.

In some implementations, when generating the unique list of terms, capability diagnostic platform 230 may exclude terms associated with stop tags or stop terms (e.g., tags or terms that identify term to be excluded from the unique list of terms). Additionally, or alternatively, capability diagnostic platform 230 may convert terms to a root form when adding the terms to the list of unique terms. For example, capability diagnostic platform 230 may convert the terms “process,” “processing,” “processed,” and “processor” to the root form “process” and may add the term “process” to the unique list of terms. In some implementations, capability diagnostic platform 230 may store the unique list of terms (e.g., in a data structure or using memory resources). This conserves processor resources by reducing or eliminating the need for capability diagnostic platform 230 to reproduce the unique list of terms.

In some implementations, capability diagnostic platform 230 may receive a file that includes the data element. For example, capability diagnostic platform 230 may receive a text file, a comma-separated values (CSV) file, a spreadsheet file (e.g., a Microsoft Excel file), and/or the like, that includes the data element. In some implementations, capability diagnostic platform 230 may process a file that includes the data element to identify the data element (e.g., rather than processing text). In some implementations, capability diagnostic platform 230 may process multiple types of files to identify a data element.

In some implementations, capability diagnostic platform 230 may receive the data element based on user input (e.g., from a user of client device 210). For example, a user may input a data element in the form of text, such as by answering a questionnaire, or by completing a survey. Additionally, or alternatively, capability diagnostic platform 230 may receive the data element based on existing data, such as an existing organization/operations plan or a document using standard industry language and/or formatting.

In some implementations, capability diagnostic platform 230 may receive the data element using a bot, a web robot, an internet bot, a script, a software monitor, or a similar type of software application. For example, capability diagnostic platform 230 may use a bot to scan hardware resources 220 associated with an organization, such as to obtain a data element, or metadata about a data element, from hardware resources 220 for analysis. This increases an efficiency of obtaining a data element from hardware resources 220.

In some implementations, a data element may relate to a technical capability of a resource of an organization. In some implementations, a technical capability of a resource may include a capability related to gathering, storing, processing, and/or providing data. Additionally, or alternatively, a technical capability of a resource may include software or other computing tools/devices used by the resource. For example, a technical capability may include an analytics capability, a data processing capability, a data storage capability, a data mining capability, a big data capability, and/or the like.

In some implementations, a data element may be associated with various aspects of a resource related to the technical capability. For example, the data element may include data related to operations of a resource associated with a technical capability. Continuing with the previous example, the data element may relate to vision and strategy of the technical capability with respect to the organization, people (e.g., skills, education, training, etc. of the people) associated with the technical capability, roles and processes associated with the technical capability, and/or the like.

Additionally, or alternatively, a data element may include data related to a functional area of an organization associated with a technical capability. For example, the data element may include data related to a technical capability of resources of different functional areas of the organization, such as a finance/accounting functional area, a human resources (HR) functional area, a marketing functional area, a sales/distribution functional area, and/or the like. Continuing with the previous example, and as a specific example, the data element may relate to an analytics capability of resources of a functional area (e.g., how effectively the functional area can perform analytics to meet needs of the organization, such as determined by data elements received via questionnaire or survey).

Additionally, or alternatively, a data element may include data related to an investment portfolio of an organization associated with a technical capability. For example, data may relate to investment in a technical capability by an organization. Continuing with the previous example, the data may relate to an amount of money, or other resources, invested in software, people with particular technical skills, etc., associated with the technical capability. As a specific example, the data element may relate to returns from investment in technology (e.g., an amount of time saved on an individual basis due to investment in particular software, an amount of revenue generated from investment in software that permitted the organization to offer new/additional services, etc.).

Additionally, or alternatively, a data element may include data related to a sub-organization of an organization (e.g., a sub-organization associated with a technical capability). For example, the data may relate to a sub-organization of the organization that provides or supports a technical capability. Continuing with the previous example, the data may relate to resources, skill sets of people related to the sub-entities, supply of a technical capability to the organization, amount of processes performed manually to provide a technical capability (e.g., manual data formatting/cleansing), and/or the like.

Additionally, or alternatively, a data element may include data related to technology associated with a technical capability (e.g., technology used to implement a technical capability). For example, the data element may relate to availability of data needed for a technical capability, techniques used to gather, process, and store data, quality governance processes, and/or the like. Continuing with the previous example, the data element may relate to types and/or versions of software used by a resource, types and/or versions of hardware used by the resource, rules related to data used for a technical capability (e.g., whether rules exist for data formatting, whether rules for data formatting are consistent across resources of the organization, etc.), computing and/or processing resources used for the technical capability (e.g., a quantity of computers available for data processing, processing power of the computers, etc.), and/or the like.

In some implementations, capability diagnostic platform 230 may store a data element. For example, capability diagnostic platform 230 may store the data element using a data structure and/or memory resources of capability diagnostic platform 230, such as in virtual storage 215-3. In some implementations, capability diagnostic platform 230 may aggregate multiple data elements. For example, capability diagnostic platform 230 may aggregate multiple data elements by aggregating the multiple data elements into a database, data structure, and/or the like. This conserves processing resources by permitting quick and efficient access to the multiple data elements. In addition, this permits processing and/or scalability that may not be possible using un-aggregated data, or that may consume significant processing resources when using un-aggregated data. Additionally, or alternatively, capability diagnostic platform 230 may de-duplicate data elements, merge sets of data elements, normalize data elements, and/or the like. In this way, capability diagnostic platform 230 conserves memory resources of capability diagnostic platform 230, and/or conserves processing resources by enabling capability diagnostic platform 230 to quickly access data elements.

In some implementations, capability diagnostic platform 230 may aggregate different types of data elements. For example, capability diagnostic platform 230 may aggregate data related to a functional area of an organization and data related to an investment portfolio of the organization. In some implementations, capability diagnostic platform 230 may aggregate data elements based on a particular attribute of the data elements. For example, capability diagnostic platform 230 may aggregate investment portfolio data using an identifier that identifies particular software. As another example, capability diagnostic platform 230 may aggregate data by functional area (e.g., using an identifier that identifies a functional area). In this way, capability diagnostic platform 230 may analyze data elements based on one or more attributes of the data elements (e.g., based on functional area, sub-organization, etc.), thereby improving analysis of the data elements.

Additionally, or alternatively, capability diagnostic platform 230 may aggregate data elements associated with different file types. For example, capability diagnostic platform 230 may aggregate data elements associated with a spreadsheet file type, a text file type, a comma-separated values (CSV) file type, and/or the like. In some implementations, capability diagnostic platform 230 may format data elements associated with different file types prior to, or in association with, aggregating the data elements associated with the different file types. For example, capability diagnostic platform 230 may apply standard spacing to the data elements, add or remove characters from the data elements, separate a single column of data elements into multiple columns of data elements, etc.

In some implementations, capability diagnostic platform 230 may aggregate and/or merge sets of data elements using a big data analytics technique, tool, application, and/or software. For example, capability diagnostic platform 230 may aggregate or merge millions, billions, trillions, etc. of data elements. In some implementations, using big data analytics may enable capability diagnostic platform 230 to aggregate and/or merge sets of data elements to identify previously unidentifiable relationships and/or trends among the data elements. For example, using big data analytics may enable capability diagnostic platform 230 to merge and/or aggregate data elements to identify/track a manner in which particular software or hardware affects revenue generated by the organization, an efficiency of the organization, a technical capability of resources of the organization, and/or the like. This improves an accuracy of analyzing the data elements by enabling capability diagnostic platform 230 to identify/track relationships among the data elements. In addition, this enables capability diagnostic platform 230 to quickly and efficiently analyze a large quantity of data elements, thereby conserving processing resources related to analyzing the data elements.

In some implementations, capability diagnostic platform 230 may process the data elements. For example, capability diagnostic platform 230 may process data elements to associate a first data element with a second data element. As a particular example, capability diagnostic platform 230 may process data elements to associate a value expended (e.g., for particular software or hardware) and time spent by individuals using the software or hardware (e.g., as determined using data from time keeping records), such as by using software and/or individual identifiers to map the value expended to the amount of time spent by the individual.

In some implementations, capability diagnostic platform 230 may determine whether a data element is corrupted or whether a data element is missing from a set of data elements. In this case, when capability diagnostic platform 230 determines that the data element is corrupted or that a data element is missing from a set of data elements, capability diagnostic platform 230 may receive a replacement data element to replace the missing or corrupted data element. For example, capability diagnostic platform 230 may receive the replacement data element based on information related to the missing or corrupted data element, based on querying hardware resources 220 for the missing or corrupted data element, based on cross-referencing data elements to determine the missing or corrupted data element, based on a user input to client device 210, or the like.

In this way, capability diagnostic platform 230 may receive data elements related to a technical capability of resources of an organization.

As further shown in FIG. 4, process 400 may include performing an analysis of the data elements to identify a deficiency related to the technical capability of the resources of the organization (block 420). For example, capability diagnostic platform 230 may perform an analysis of a data element and a threshold data element to identify a deficiency related to the technical capability of one or more resources of the organization. In some implementations, capability diagnostic platform 230 may perform the analysis based on receiving an indication to perform the analysis (e.g., from a user of client device 210), based on receiving a threshold quantity of data elements, and/or the like. In some implementations, the deficiency may negatively impact the organization by, for example, reducing an efficiency of a process, consuming processing resources, increasing an amount of time related to performing a process, and/or the like.

In some implementations, a threshold data element may include a benchmark data element, a data element defined by a user of client device 210 and/or capability diagnostic platform 230, or a data element defined by an industry standard. In some implementations, a threshold data element may include a data element determined based on other entities. For example, capability diagnostic platform 230 may have analyzed other entities and identified threshold data elements (e.g., average data elements) across the other entities.

In some implementations, capability diagnostic platform 230 may perform a comparison of the data element and a threshold data element. In some implementations, capability diagnostic platform 230 may compare a data element identifying processing resources of the organization to a threshold data element identifying a threshold amount of processing resources needed to perform a particular type of technical capability (e.g., a big data capability or an analytics capability). In this way, capability diagnostic platform 230 may quickly and efficiently analyze processing resources of an organization that are related to a technical capability. Additionally, or alternatively, capability diagnostic platform 230 may compare a data element identifying skill sets of people related to the organization and a threshold data element identifying skill sets needed to implement a particular technical capability (e.g., by comparing terms). In this way, capability diagnostic platform 230 may analyze skill sets of people associated with an organization as the skill sets relate to implementing a technical capability.

Additionally, or alternatively, capability diagnostic platform 230 may compare a data element identifying terms and/or tags from vision/strategy documentation of the organization and pre-defined terms and/or tags that indicate a vision and/or strategy oriented toward a technical capability. In some implementations, capability diagnostic platform 230 may determine a similarity between terms and/or tags from vision/strategy documentation of the organization and pre-defined terms and/or tags. For example, capability diagnostic platform 230 may determine a similarity using a semantic matching analysis. In this way, capability diagnostic platform 230 may perform a comparison of data elements related to various aspects of a technical capability of resources of an organization.

In some implementations, capability diagnostic platform 230 may determine a semantic similarity between terms and/or tags associated with the vision/strategy documentation of the organization and pre-defined terms and/or tags. For example, capability diagnostic platform 230 may determine whether a phrase that appears in a vision/strategy document of the organization, such as “prioritize technological investments,” is semantically similar to a phrase found in vision/strategy documentation for other entities, such as “invest in technology.” In this way, capability diagnostic platform 230 may determine whether vision/strategy documentation of an organization prioritizes improving technological investments, is similar to other similar entities, satisfies an industry norm, and/or the like.

Additionally, or alternatively, capability diagnostic platform 230 may compare a data element identifying types and/or versions of software associated with a technical capability and a threshold data element identifying software types and/or versions used by other entities to implement a similar technical capability. In this way, capability diagnostic platform 230 may analyze software used by the organization to implement a technical capability. Additionally, or alternatively, capability diagnostic platform 230 may compare a data element identifying hardware resources of an organization and a threshold data element for such technical capability. For example, a hardware capability may include a data storage capacity, availability of replacement resources in the event of a hardware failure (e.g., redundancy, etc.), and/or the like. In this way, capability diagnostic platform 230 may analyze hardware resources 220 related to a technical capability.

Additionally, or alternatively, capability diagnostic platform 230 may compare a data element identifying spending on different technical capabilities to a benchmark investment structure associated with an industry, size, type, etc., of the organization. In this way, capability diagnostic platform 230 may analyze an investment in a technical capability.

In some implementations, capability diagnostic platform 230 may perform the comparison to determine a state of the technical capability (e.g., a high, medium, or low state relative to other entities, an industry standard, etc.). For example, capability diagnostic platform 230 may determine a high state when the data element satisfies a first threshold, a medium state when the data element satisfies a second threshold but does not satisfy the first threshold, a low state when the data element does not satisfy the first threshold or the second threshold, and/or the like.

In some implementations, capability diagnostic platform 230 may perform the comparison to identify a deficiency related to a technical capability of resources of the organization. For example, a deficiency may include a technical capability that does not satisfy a threshold state, has a lower state relative to another organization, does not satisfy specifications detailed by the organization, and/or the like. Continuing with the previous example, capability diagnostic platform 230 may determine that processing/computing resources of an organization are insufficient for a particular technical capability, that software is out of date relative to other entities, that an organization does not have people with proper skill sets needed to implement a technical capability, and/or the like. In this way, capability diagnostic platform 230 may quickly and accurately identify a deficiency related to a technical capability, thereby conserving processing resources.

In some implementations, capability diagnostic platform 230 may determine whether a first data element satisfies a threshold based on whether a second data element satisfies a second threshold. In other words, the first data element may be dependent on the second data element.

In some implementations, capability diagnostic platform 230 may generate a score based on the comparison. For example, capability diagnostic platform 230 may generate a score that indicates a severity of the deficiency. In some implementations, capability diagnostic platform 230 may base the score on whether the data element satisfies a threshold data element, an extent to which the data element satisfies or does not satisfy a threshold (e.g., a percentage by which a threshold is satisfied or not satisfied, an amount by which a threshold is satisfied or not satisfied, etc.), terms and/or tags included in the data element (e.g., where a particular term and/or tag is associated, in a data structure, with a particular severity or score), and/or the like. In this way, capability diagnostic platform 230 may generate a score and/or determine a severity of a deficiency. This increases an efficiency of facilitating fixing of the deficiency by permitting capability diagnostic platform 230 to prioritize the deficiency relative to other deficiencies.

In some implementations, capability diagnostic platform 230 may create a model using machine learning (e.g., to analyze the data elements). For example, capability diagnostic platform 230 may create the model using a training set of data that includes data elements related to other entities. In some implementations, capability diagnostic platform 230 may input data elements associated with the organization being analyzed into the model (e.g., to analyze the data elements). In some implementations, capability diagnostic platform 230 may identify a deficiency relating to a technical capability of resources of the organization based on outputs of the model.

In this way, capability diagnostic platform 230 may perform an analysis of data elements to identify a deficiency related to a technical capability of resources of the organization.

As further shown in FIG. 4, process 400 may include generating an output that indicates a priority related to the deficiency (block 430). For example, capability diagnostic platform 230 may generate an output that indicates a priority related to the deficiency. In some implementations, capability diagnostic platform 230 may generate the output based on performing the analysis.

In some implementations, the output may indicate a priority related to the deficiency. For example, the output may indicate a priority of a deficiency relative to another deficiency. In some implementations, the output may indicate a severity of the deficiency. For example, the output may indicate a severity of the deficiency relative to another deficiency, relative to a threshold, and/or the like.

In some implementations, the output may indicate the priority using color coding, scores, weights, and/or the like. For example, the output may use the colors green, yellow, and red to indicate various priorities of various deficiencies. Continuing with the previous example, when capability diagnostic platform 230 generates the output, capability diagnostic platform 230 may color code information identifying a deficiency with the color green when capability diagnostic platform 230 determines that the deficiency is a low priority deficiency (e.g., when the deficiency is within a threshold amount of a benchmark), the color yellow when the deficiency is a moderate priority deficiency (e.g., when the deficiency satisfies a first threshold but not a second threshold), and the color red when the deficiency is a high priority deficiency (e.g., when the deficiency fails to satisfy a threshold).

In some implementations, capability diagnostic platform 230 may determine the priority for the deficiency when generating the output. For example, capability diagnostic platform 230 may determine the priority based on a score associated with the deficiency, a weight associated with the deficiency, another deficiency that is similar to the deficiency (e.g., as identified using artificial intelligence), and/or the like. In some implementations, capability diagnostic platform 230 may provide the prioritized output for display after generating the prioritized output.

In this way, capability diagnostic platform 230 may generate an output that indicates a priority related to a deficiency.

As further shown in FIG. 4, process 400 may include generating an action item to positively impact the deficiency (block 440). For example, capability diagnostic platform 230 may generate an action item to positively impact the deficiency. A positive impact may occur when an action item causes a desired result, action, etc., to be achieved or increases the likelihood that a desired result, action, etc., will be achieved. In some implementations, capability diagnostic platform 230 may generate the action item based on determining the deficiency or generating the prioritized output.

In some implementations, capability diagnostic platform 230 may use artificial intelligence to identify a set of action items based on the identified deficiency. In some implementations, capability diagnostic platform 230 may generate a corresponding likelihood of success or predicted impact of the set of action items. For example, the artificial intelligence can be trained on data elements from other entities and action items generated for the other entities. Continuing with the previous example, the artificial intelligence can be trained on impacts (positive or negative) that action items have had on deficiencies for the other entities.

In some implementations, capability diagnostic platform 230 may generate an action item based on the deficiency identified (e.g., a result of the comparison). In some implementations, capability diagnostic platform 230 may generate an action item to update software and/or upgrade hardware associated with a technical capability, such as to perform a technical capability faster, more efficiently, and/or the like. This conserves processing resources of devices used to implement the technical capability, increases efficiency of implementing the technical capability, and/or the like. Additionally, or alternatively, capability diagnostic platform 230 may generate an action item to obtain additional computing/processing/storage resources. This improves implementation of the technical capability via increased computing/processing/storage resources, which may permit a device used to implement the technical capability to perform tasks more quickly, to process more data, to process data faster, and/or the like.

Additionally, or alternatively, capability diagnostic platform 230 may generate an action item to hire people with a particular skill set (e.g., a technical skill set). This improves implementation of the technical capability and conserves processing resources of devices used to implement the technical capability via a reduced quantity of errors due to inexperienced users of the devices, fewer repetitions of processes due to inexperienced users of the devices, and/or the like. Additionally, or alternatively, capability diagnostic platform 230 may generate an action item to implement data formatting rules for data used to implement the technical capability, thereby improving the technical capability. This conserves processing resources of devices used to implement the technical capability by reducing errors due to inconsistent or improper formatting of data, data cleansing due to inconsistent or improper formatting, and/or the like.

Additionally, or alternatively, capability diagnostic platform 230 may generate an action item to develop or update vision/strategy documentation related to the technical capability. Additionally, or alternatively, capability diagnostic platform 230 may generate an action item to reduce or increase investment in particular technology related to a technical capability. Additionally, or alternatively, capability diagnostic platform 230 may generate an action item to increase utilization of analytics (e.g., big data) in a particular field, market, etc., of the organization. Additionally, or alternatively, capability diagnostic platform 230 may generate an action item to increase awareness and/or knowledge of the organization with regard to subject matter associated with the deficiency (e.g., provide instructions for further research and/or topics of exploration, automatically perform research (e.g., crawl the web) based on terms related to subject matter associated with the deficiency, and/or the like). In this way, capability diagnostic platform 230 may improve implementation of the technical capability.

In some implementations, capability diagnostic platform 230 may generate an action item based on a severity of the deficiency (e.g., as indicated by a score generated for the deficiency). For example, capability diagnostic platform 230 may generate a single action item, such as obtaining software, when the severity of the deficiency satisfies a first threshold and may generate multiple action items, such as obtaining software and triggering an alert, when the severity of the deficiency satisfies a second threshold. In this way, capability diagnostic platform 230 dynamically adjusts generation of an action item based on a severity of the deficiency, thereby improving facilitation of fixing of the deficiency.

In some implementations, capability diagnostic platform 230 may generate an action item based on a previously generated action item. For example, capability diagnostic platform 230 may generate an action item by identifying an action item generated for a similar organization (e.g., in a similar industry, of a similar size, etc.) that has a similar deficiency. Continuing with the previous example, assuming that a first action item to download software was generated to positively impact a deficiency related to an analytics capability of resources of a first organization, capability diagnostic platform 230 may generate an action item to download software to positively impact a similar deficiency related to an analytics capability of resources of a second organization (e.g., where both deficiencies relate to out-of-date software). This conserves processing resources of capability diagnostic platform 230 by increasing an efficiency of generating an action item.

In some implementations, capability diagnostic platform 230 may generate a score for the action item. For example, capability diagnostic platform 230 may generate a score that indicates a priority for the action item. In some implementations, capability diagnostic platform 230 may generate a score based on a variety of factors, as described below.

In some implementations, capability diagnostic platform 230 may generate a score based on an amount of time needed to complete the action item. For example, capability diagnostic platform 230 may generate a score based on an amount of time for similar action items implemented by other entities. Additionally, or alternatively, capability diagnostic platform 230 may generate a score based on a positive impact of the action item relative to another action item (e.g., an amount by which the action item is to positively impact a deficiency). For example, an action item that can change an organization's state for a technical capability from low to high may receive a higher score than an action item that can change a state of a technical capability from low to medium or medium to high.

Additionally, or alternatively, capability diagnostic platform 230 may generate a score based on an ease of performing the action item (e.g., whether the action item includes performance of a manual action). For example, an action item that can be performed automatically may receive a higher score than an action item that includes a manual action to be performed. Additionally, or alternatively, capability diagnostic platform 230 may generate a score based on a quantity of people, associated with the organization, that may be needed to perform the action item or that may be affected by the action item. For example, an action item that may affect a higher quantity of people associated with the organization may receive a higher score. As another example, an action that may need a higher quantity of people to implement may receive a lower score.

pAdditionally, or alternatively, capability diagnostic platform 230 may generate a score based on a cost of performing the action item satisfying a threshold, or relative to another action item. In this case, capability diagnostic platform 230 may determine the cost using historical data from analysis of other entities.

In some implementations, the action item may positively impact the deficiency. For example, the action item may reduce the deficiency, eliminate the deficiency, minimize the deficiency, and/or the like. As a particular example, the action item may change a state of a technical capability (e.g., from low to high, medium to high, etc.), may cause the technical capability to satisfy an industry standard (e.g., as determined using data elements associated with the technical capability and the industry standard), and/or the like.

In some implementations, capability diagnostic platform 230 may associate multiple action items together. For example, capability diagnostic platform 230 may associate multiple action items to form a set of instructions or an action plan, may associate action items that relate to the same technical capability, may associate action items that can be performed simultaneously (e.g., updating different software), and/or the like. In this way, capability diagnostic platform 230 increases an efficiency of performing actions related to multiple action items, thereby conserving processing resources.

In some implementations, capability diagnostic platform 230 may identify an individual associated with the organization (e.g., an employee, a director, etc.) and may associate information identifying the individual with the action item. For example, capability diagnostic platform 230 may identify an individual to perform the action item, or to be responsible for completion of the action item. In some implementations, capability diagnostic platform 230 may identify the individual by processing a text document that describes duties and/or responsibilities of the individual, such as a role description, a responsibility description, an organizational chart, and/or the like, to identify a particular term and/or tag associated with the individual that matches a term and/or tag associated with the action item. In some implementations, capability diagnostic platform 230 may store information identifying the individual and a particular action item.

In this way, capability diagnostic platform 230 may generate an action item to positively impact a deficiency of a technical capability based on performing a comparison.

As further shown in FIG. 4, process 400 may include performing an action associated with the action item to positively impact the deficiency (block 450). For example, capability diagnostic platform 230 may perform an action associated with the action item to positively impact the deficiency. In some implementations, capability diagnostic platform 230 may perform the action after generating the action item.

In some implementations, capability diagnostic platform 230 may obtain software for hardware resources 220 and may install the software on the hardware resources 220. For example, if capability diagnostic platform 230 determines that particular software used for a technical capability needs to be updated, capability diagnostic platform 230 may obtain the software and install the software on hardware resources 220. This conserves processing resources of hardware resources 220 by reducing or eliminating a need for hardware resources 220 to obtain the software. Additionally, or alternatively, capability diagnostic platform 230 may place an order for hardware. For example, if capability diagnostic platform 230 determines that the organization needs additional processing and/or computing resources to implement a technical capability, capability diagnostic platform 230 may generate and place an order for one or more computers that have a threshold amount of processing resources. This improves implementation of a technical capability by increasing processing resources used to implement the technical capability.

Additionally, or alternatively, capability diagnostic platform 230 may generate a job posting for people with a particular skill set and may post the job posting to a job posting site. For example, if capability diagnostic platform 230 determines that the organization does not have employees with a threshold quantity of years of experience in data analytics, capability diagnostic platform 230 may generate a job positing for one or more individuals with a threshold quantity of years of experience in data analytics (e.g., by generating a job posting that includes particular terms). In this way, capability diagnostic platform 230 may facilitate hiring of individuals with skills needed to implement or improve a technical capability.

Additionally, or alternatively, capability diagnostic platform 230 may generate a report. For example, capability diagnostic platform 230 may generate a report that identifies the action item and/or a result of performing the action item (e.g., an amount or percentage by which a deficiency is predicted to be reduced, an amount or percentage by which computing and/or processing resources are predicted to increase by implementing the action item, etc.). As another example, capability diagnostic platform 230 may generate a report that identifies deficiencies associated with a technical capability. In some implementations, capability diagnostic platform 230 may provide the report for display (e.g., via client device 210). In this way, capability diagnostic platform 230 may communicate a result of identifying a deficiency.

In some implementations, capability diagnostic platform 230 may generate a report in real-time, or near real-time, as data elements are received. In this way, capability diagnostic platform 230 may generate reports with increased accuracy, thereby conserving processing resources when an action is performed based on the report by reducing or eliminating inefficient actions, ineffective actions, and/or the like. In addition, this improves a technical capability of resources of an organization relative to an analysis that is not in real-time or near real-time by reducing an amount of time between when a deficiency is detected and when an action is performed to positively impact the deficiency.

In some implementations, capability diagnostic platform 230 may store a result of analyzing the technical capability. For example, capability diagnostic platform 230 may store information identifying the result, such as a report, using memory resources of capability diagnostic platform 230. Additionally, or alternatively, capability diagnostic platform 230 may provide a result of analyzing the technical capability to another device for storage. For example, capability diagnostic platform 230 may provide the result to hardware resources 220 to cause hardware resources 220 to store the result. This conserves processing resources of capability diagnostic platform 230 by reducing or eliminating a need for capability diagnostic platform 230 to perform the same analysis multiple times. In addition, this improves future analyses of capability diagnostic platform 230 by creating a historical record of prior analyses that capability diagnostic platform 230 can analyze to identify patterns, trends, and/or the like (e.g., using data mining).

Additionally, or alternatively, capability diagnostic platform 230 may schedule a meeting. For example, capability diagnostic platform 230 may schedule a meeting to discuss identified deficiencies, a recommended action item, and/or a result of performing the action item. In this case, capability diagnostic platform 230 may use electronic calendars associated with people related to the organization to identify an available time.

In some implementations, capability diagnostic platform 230 may aggregate data related to analyzing the technical capability (e.g. a received data element, data identifying a generated action item, and/or data identifying a result of an action item) with data from analyzing other entities. In this way, capability diagnostic platform 230 may generate a dynamic data store with increasing amounts of data. This increases an accuracy of analyses using the data (e.g., via analysis of historical data), thereby conserving processing resources that would otherwise be used to inaccurately analyze a technical capability. Further, this permits capability diagnostic platform 230 to dynamically adjust threshold data used in analyses (e.g., as additional data is added to the data store), thereby improving accuracy of the analyses.

In some implementations, capability diagnostic platform 230 may use the aggregated data to identify trends among various entities (e.g., changes to industry practices, aging technical capabilities, common deficiencies across an industry, etc.) using pattern recognition, machine learning, big data analysis, artificial intelligence, and/or the like. In some implementations, capability diagnostic platform 230 may generate recommendations related to service offerings or marketing opportunities based on identifying the trends (e.g., based on identifying a trend across an industry related to software used for various technical capabilities, a particular deficiency identified in a threshold quantity of analyses, etc.). Additionally, or alternatively, capability diagnostic platform 230 may use the aggregated data to improve analysis of another organization (e.g., via use of machine learning, artificial intelligence, etc.), such as by improving identification of a deficiency, improving action item generation, and/or the like.

In some implementations, capability diagnostic platform 230 may use the aggregated data to identify similar entities and the types of deficiencies identified for the similar entities (e.g., using a big data analysis technique, pattern recognition, etc.). In this way, capability diagnostic platform 230 improves identification of deficiencies for entities similar to previously analyzed entities. This conserves processing resources of capability diagnostic platform 230 by reducing an amount of time needed to analyze an organization that is similar to previously analyzed entities.

In some implementations, capability diagnostic platform 230 may send a message (e.g., a short message service (SMS) message, an email, etc.). For example, capability diagnostic platform 230 may send a message to client device 210 that includes instructions for performing the action item (e.g., for display, to cause client device 210 to perform the action, or to cause a user of client device 210 to perform the action).

In this way, capability diagnostic platform 230 may perform an action associated with the action item to positively impact the deficiency.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

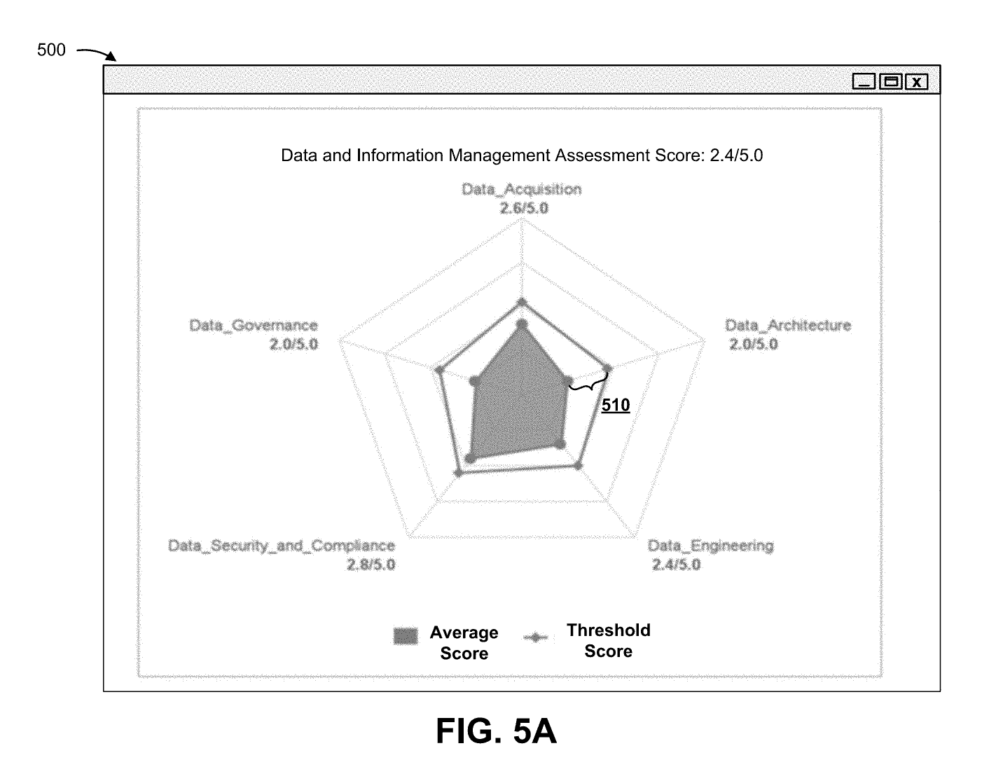

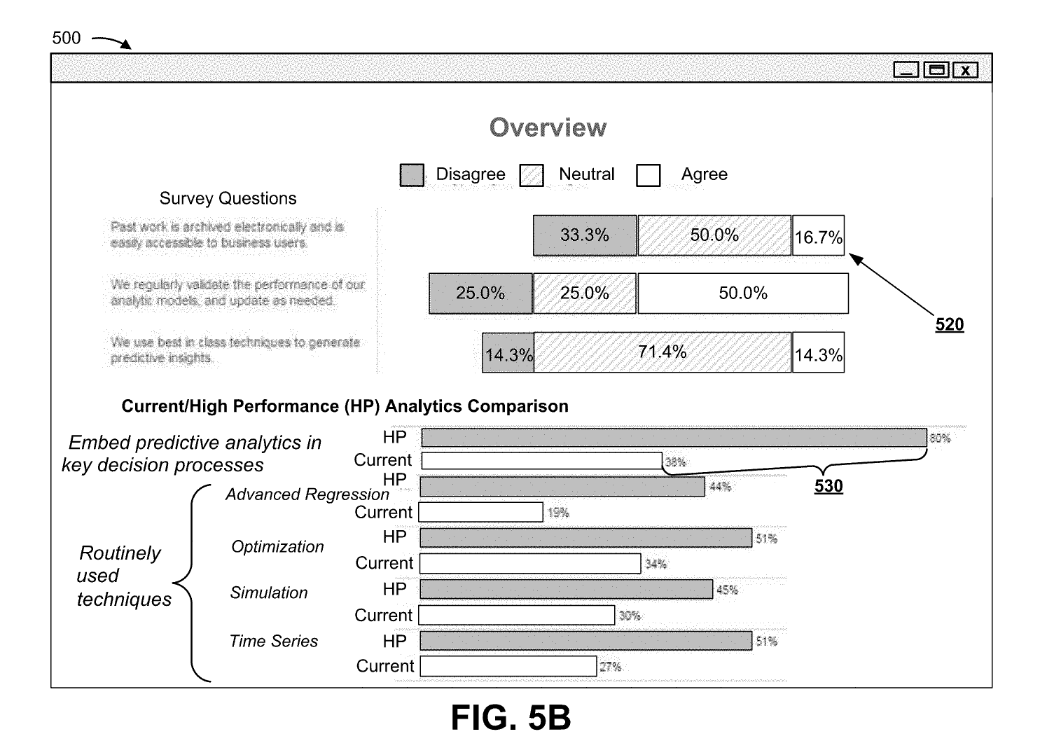

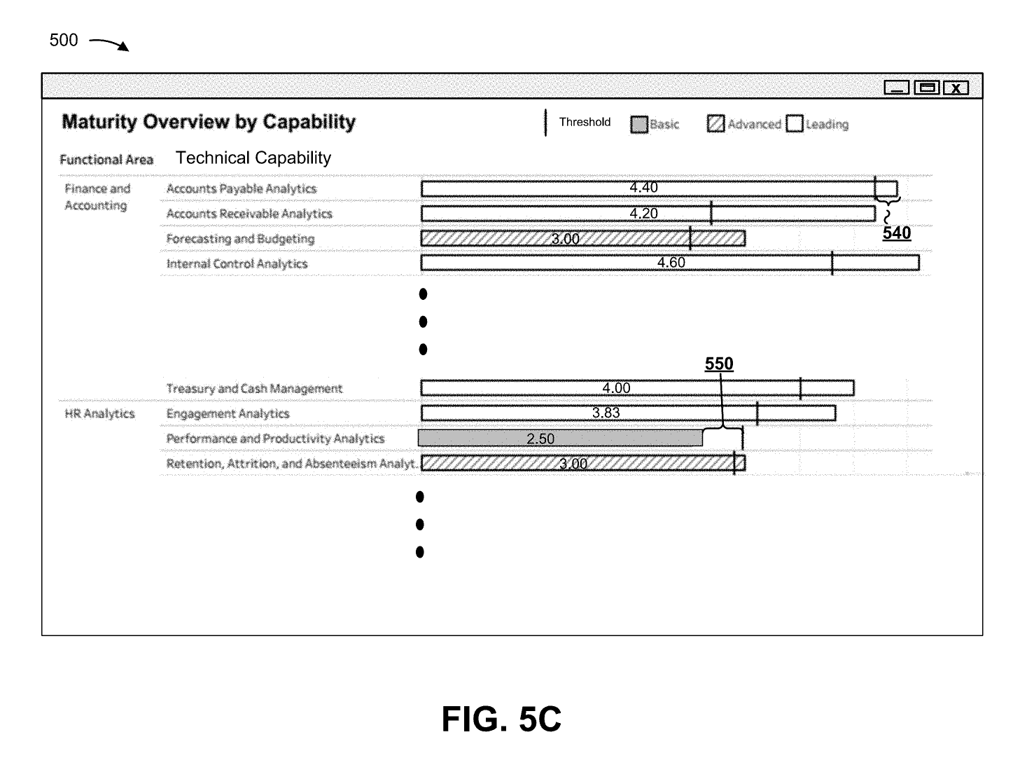

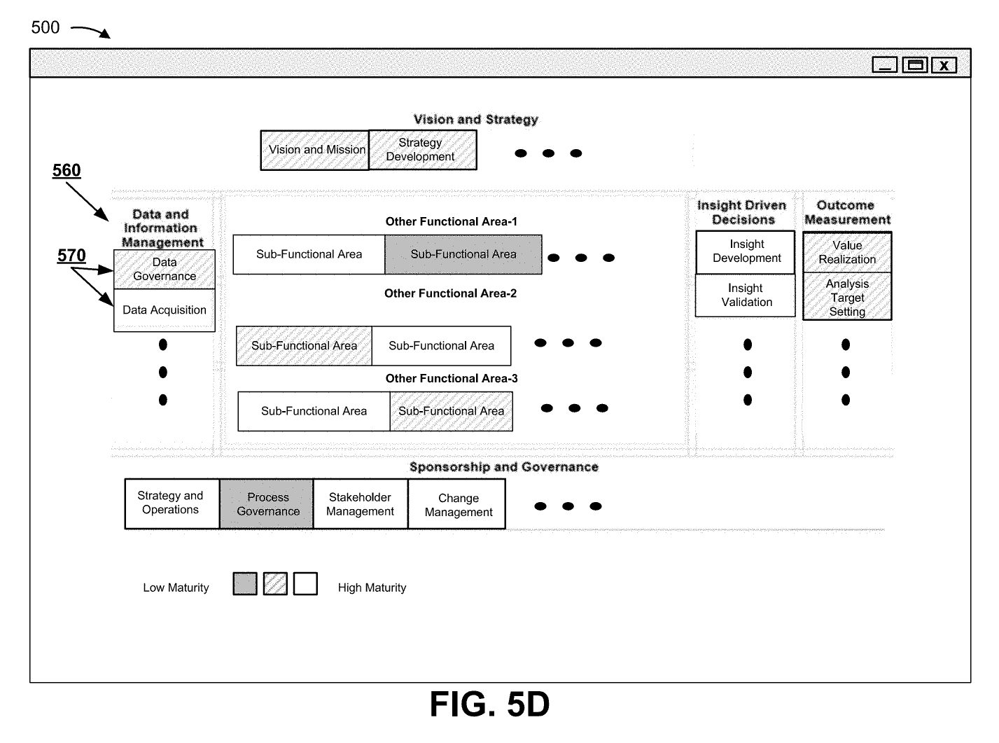

FIGS. 5A-5D are diagrams of an example implementation 500 relating to example process 400 shown in FIG. 4. FIGS. 5A-5D show example outputs that capability diagnostic platform 230 may generate. In some implementations, the outputs may be related to a technical capability of an organization.

For example, as shown in FIG. 5A, capability diagnostic platform 230 may generate a spider web type diagram for a data and information management capability. In some implementations, the output may display a score for the data and information management capability (e.g., a score of 2.4 out of 5, shown as “2.4/5.0”). As further shown in FIG. 5A, the output may identify sub-capabilities related to the technical capability (e.g., shown as “Data_Acquisition” for a data acquisition sub-capability, “Data_Architecture” for a data architecture sub-capability, etc.) and corresponding scores for the sub-capabilities (e.g., shown as “2.6/5.0,” “2.0/5.0,” etc.).

In some implementations, the output may display information related to a threshold capability (e.g., a threshold score, a benchmark score, etc.) on the diagram. In addition, the output may display information related to the sub-capabilities on the diagram. For example, the output may display scores for the sub-capabilities relative to the threshold.

In some implementations, capability diagnostic platform 230 may analyze the output to identify a deficiency related to the technical capability or the sub-capabilities. For example, as shown by reference number 510, capability diagnostic platform 230 may identify a deficiency when a score for a data architecture sub-capability does not satisfy a threshold score. In this way, capability diagnostic platform 230 may quickly and efficiently identify a deficiency related to a technical capability. In addition, in this way, capability diagnostic platform 230 may provide output that permits easy identification of a deficiency.

As shown in FIG. 5B, capability diagnostic platform 230 may generate output related to answers to a survey. For example, as shown by reference number 520, capability diagnostic platform 230 may generate output that shows a percentage of respondents that selected “Disagree,” “Neutral,” or “Agree” as an answer to the question “Past work is archived electronically and is easily accessible to business users.” Continuing with the previous example, capability diagnostic platform 230 may display information indicating that 33.3 percent of people responding to the previously described survey question answered “Disagree” (shown as “33.3%”), that 50.0 percent of people answered “Neutral” (shown as “50.0%”), and that 16.7 percent answered “Agree” (shown as “16.7%”).

As further shown in FIG. 5B, capability diagnostic platform 230 may display information that compares current analytics practices of an organization to the analytics practices of an organization identified as a high performing organization. For example, as shown in FIG. 5B under the heading “Current/High Performance (HP) Analytics Comparison,” the output may show a comparison of the current analytics practices of an organization being analyzed by capability diagnostic platform 230 (e.g., shown as “Current”) and the practices of an analytics capability of a high performing organization (e.g., shown as “HP”).

As shown by reference number 530, and as an example, the output may show that 38 percent (e.g., shown as “38%”) of survey responses positively indicate that the organization being analyzed embeds predictive analytics in key decision processes and that this is a deficiency relative to a high performing organization (e.g., where 80 percent (e.g., shown as “80%”) of survey responses have the positive indication). In this way, capability diagnostic platform may generate output and/or use output to identify a deficiency related to practices of an organization associated with a technical capability.

As shown in FIG. 5C, capability diagnostic platform 230 may generate output that displays information identifying a maturity of a technical capability of an organization. For example, a maturity of a technical capability may indicate whether software/hardware used by the organization is current, whether processes related to the technical capability satisfy industry standards, an amount of training individuals associated with the organization have received with respect to the technical capability, and/or the like. In some implementations, the output may identify whether the maturity of the technical capability is basic, advanced, or leading (e.g., relative to a threshold), where, for example, the maturity of a technical capability may be basic when the maturity does not satisfy a threshold, advanced when the maturity satisfies the threshold, or leading when the maturity satisfies the threshold by a threshold amount.

As shown by reference number 540, the output may show that a maturity for an accounts payable analytics capability is advanced based on satisfying a threshold by a threshold amount. Similarly, as shown by reference number 550, the output may show that a maturity for a performance and productivity analytics capability is basic based on failing to satisfy a threshold. In this way, displaying information in this manner may permit capability diagnostic platform 230 to identify a maturity of a technical capability and/or an amount by which a maturity of the technical capability satisfies or does not satisfy a threshold.

As shown in FIG. 5D, the output may include a heat map type output. As shown by reference number 560, the output may identify various functional areas of an organization (e.g., shown as “Data and Information Management,” “Vision and Strategy,” “Sponsorship and Governance,” etc.). As shown by reference number 570, the output may display sub-functional areas related to each functional area shown on the output. In addition, as shown by reference number 570, information displayed by the output may indicate a maturity of a technical capability of the sub-functional areas. For example, the output may indicate that a technical capability of a data governance sub-functional area has a medium maturity (e.g., as indicated by the square, with a diagonal line pattern, displaying the text “data governance”). As another example, the output may indicate that a technical capability of a data acquisition functional area has a high maturity (e.g., as indicated by the white square displaying the text “data acquisition”). In this way, capability diagnostic platform 230 may generate an output that shows a maturity of a technical capability of a functional area of an organization.

In some implementations, capability diagnostic platform 230 may use the output to identify a deficiency (e.g., where a score shown by the output does not satisfy a threshold, where a maturity identified by the output does not satisfy a threshold, etc.). Additionally, or alternatively, capability diagnostic platform 230 may use the output to prioritize deficiencies to fix (e.g., based on a score included in the output, based on a maturity identified by the output, etc.).

As indicated above, FIGS. 5A-5D are provided merely as an example. Other examples are possible and may differ from what was described with regard to FIGS. 5A-5D.

Implementations described herein enable a capability diagnostic platform to gather and analyze data related to a technical capability of resources of an organization. In this way, the capability diagnostic platform enables identification of a deficiency related to the technical capability, and/or enables facilitation of fixing the deficiency, thereby improving a technical capability of resources of the organization. Furthermore, in this way, the capability diagnostic platform improves processing and/or computing resources of the organization, thereby improving an efficiency of the organization. Furthermore, in this way, the capability diagnostic platform enables quick and efficient analysis of a technical capability of resources of an organization, thereby conserving processing and/or computing resources.

The foregoing disclosure provides illustration and description, but is not intended to be exhaustive or to limit the implementations to the precise form disclosed. Modifications and variations are possible in light of the above disclosure or may be acquired from practice of the implementations.

As used herein, the term component is intended to be broadly construed as hardware, firmware, and/or a combination of hardware and software.

Some implementations are described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, etc.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware can be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Furthermore, as used herein, the term “set” is intended to include one or more items (e.g., related items, unrelated items, a combination of related and unrelated items, etc.), and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

What is claimed is:

1. A device, comprising:
one or more processors to:
receive multiple data elements related to a technical capability of resources of an organization,
the technical capability being associated with gathering, storing, processing, or providing data,
the multiple data elements including at least one qualitative data element;
store the multiple data elements in one or more storage devices associated with the device;
identify a deficiency related to the technical capability of resources of the organization based on analyzing the multiple data elements,
the deficiency negatively impacting the technical capability of resources of the organization,
the deficiency being identified via a quantitative determination with respect to threshold data;
generate an output that indicates a first priority related to the deficiency based on identifying the deficiency;
generate multiple action items to perform based on the output,
the multiple action items to positively impact the deficiency; and
perform an action associated with the multiple action items based on generating the multiple action items,
the action to positively impact the deficiency in a quantitative manner with respect to the threshold data.

2. The device of claim 1, where the one or more processors are further to:
generate a score for the deficiency based on analyzing the multiple data elements, the score indicating a severity of the deficiency; and
where the one or more processors, when generating the multiple actions items, are to:
generate the multiple action items based on the severity of the deficiency.

3. The device of claim 1, where the one or more processors are further to:
determine a second priority of the multiple action items based on generating the multiple action items; and
where the one or more processors, when performing the action, are to:
perform the action based on the second priority of the multiple action items.

4. The device of claim 1, where the one or more processors are further to:
identify multiple other action items generated for a technical capability of resources of multiple other organizations,
the multiple other organizations being in same field as the organization; and
where the one or more processors, when generating the multiple action items, are to:
generate the multiple action items based on identifying the multiple other action items.

5. The device of claim 1, where the one or more processors, when receiving the multiple data elements, are to:
receive one or more of the multiple data elements as one or more responses to a questionnaire or a survey;
determine a score for the technical capability based on the one or more responses; and
where the one or more processors, when identifying the deficiency, are to:
identify the deficiency based on determining the score for the technical capability.

6. The device of claim 1, where the one or more processors, when generating the multiple action items, are to:
generate an action item to obtain software based on identifying the deficiency; and
where the one or more processors, when performing the action, are to:
obtain the software based on generating the action item to obtain the software, and
cause a client device to install the software.

7. The device of claim 1, where the deficiency relates to:
a quantity of computing devices associated with the technical capability,
an amount of computing resources associated with the technical capability,
an amount of processing resources associated with the technical capability, or
software associated with the technical capability.

8. A method, comprising:
receiving, by a device, a plurality of data elements related to a technical capability of resources of an organization,
the technical capability including an analytics capability, a data processing capability, or a big data capability;
storing, by the device, the plurality of data elements in one or more storage devices associated with the device;
performing, by the device, an analysis of the plurality of data elements to identify a deficiency related to the technical capability of resources of the organization,
the deficiency negatively impacting the technical capability of resources of the organization;
generating, by the device, a plurality of action items to perform based on identifying the deficiency,
the plurality of action items to positively impact the deficiency,
the plurality of action items being based on the deficiency; and
performing, by the device, an action associated with the plurality of action items to positively impact the deficiency.

9. The method of claim 8, further comprising:
determining a first score and a second score for the technical capability based on receiving the plurality of data elements; and
where performing the analysis comprises:
performing the analysis of the plurality of data elements based on the first score and the second score,
the second score being based on one or more organizations that are different from the organization.

10. The method of claim 8, further comprising:
aggregating the plurality of data elements with other data elements to form aggregated data elements; and
identifying another deficiency for another organization using the aggregated data elements based on aggregating the plurality of data elements.

11. The method of claim 8, further comprising:
processing text to identify first terms included in the text based on receiving the plurality of data elements,
the text being associated with the technical capability,
the plurality of data elements including the text;
performing an analysis of the first terms and second terms to determine whether the first terms and the second terms are semantically similar,
the second terms being associated with a threshold state of technical capabilities; and
the deficiency being identified based on a result of the analysis of the first terms and the second terms.

12. The method of claim 8, further comprising:
determining a severity for the deficiency based on performing the analysis,
the severity being based on at least one of:
an extent to which the plurality of data elements satisfies a threshold data element,
a term or tag identified from the plurality of data elements, or
a similarity of the deficiency to another deficiency with a known severity; and
where generating the plurality of action items comprises:
generating the plurality of action items based on determining the severity of the deficiency.

13. The method of claim 8, where performing the action comprises:
generating a recommendation to hire one or more individuals with a particular skill based on identifying the deficiency; and
generating a job posting based on generating the recommendation,
the job posting including information identifying the particular skill.

14. The method of claim 8, where the plurality of data elements relate to:
a functional area of the organization associated with the technical capability,
an operation of the organization associated with the technical capability,
an investment portfolio of the organization associated with the technical capability,
a sub-organization of the organization associated with the technical capability, or
technology used to implement the technical capability.

15. A non-transitory computer-readable medium storing instructions, the instructions comprising:
one or more instructions that, when executed by one or more processors of one or more computing devices of a cloud computing environment, cause the one or more processors to:
receive multiple data elements related to a technical capability of resources of an organization,
the technical capability being associated with gathering, storing, processing, or providing data,
the multiple data elements being received from one or more hardware resources of the organization;
store the multiple data elements in one or more storage devices associated with the cloud computing environment,
the one or more storage devices storing multiple other data elements associated with one or more other organizations;
perform an analysis of the multiple data elements to identify a deficiency related to the technical capability of resources of the organization;
generate multiple action items to perform based on identifying the deficiency,
the multiple action items to reduce the deficiency; and
perform an action associated with the multiple action items to positively impact the deficiency.

16. The non-transitory computer-readable medium of claim 15, where the one or more instructions, when executed by the one or more processors, further cause the one or more processors to:
identify a first term in a document associated with the technical capability based on receiving the multiple data elements;
determine a semantic similarity between the first term and a second term based on a result of performing the analysis,
the second term being a pre-defined term associated with a particular state of technical capabilities; and
where the one or more instructions, that cause the one or more processors to identify the deficiency, cause the one or more processors to:
identify the deficiency based on determining the semantic similarity between the first term and the second term.

17. The non-transitory computer-readable medium of claim 15, where the one or more instructions, when executed by the one or more processors, further cause the one or more processors to:
determine a score for an action item, of the multiple action items, based on at least one of:
an amount of time needed to complete the action item,
an amount by which the action item is predicted to positively impact the deficiency,
whether the action item includes performance of a manual action,
a first quantity of people, associated with the organization, that are predicted to be needed to perform the action item,
a second quantity of people, associated with the organization, that are predicted to be affected by the action item, or
a cost of performing the action item;
determine a priority of the action item based on the score; and
where the one or more instructions, that cause the one or more processors to perform the action, cause the one or more processors to:
perform the action item based on the priority of the action item,
the action item being associated with the action.

18. The non-transitory computer-readable medium of claim 15, where the one or more instructions, that cause the one or more processors to perform the action, cause the one or more processors to:
generate a report that identifies the deficiency; and
provide the report to a client device.

19. The non-transitory computer-readable medium of claim 15, where the one or more instructions, that cause the one or more processors to perform the analysis, cause the one or more processors to:
perform a comparison of the multiple data elements and a threshold data element after storing the multiple data elements,
the threshold data element being based on at least one of:
multiple other data elements associated with other organizations,
an industry standard, or
a threshold defined by a user of a client device; and
where the one or more instructions, that cause the one or more processors to generate the multiple action items, cause the one or more processors to:
generate the multiple action items based on performing the comparison.

20. The non-transitory computer-readable medium of claim 15, where the one or more instructions, when executed by the one or more processors, further cause the one or more processors to:
identify a trend across multiple organizations based on the multiple data elements and multiple other data elements associated with other organizations; and
where the one or more instructions, that cause the one or more processors to generate the multiple action items, cause the one or more processors to:
generate the multiple actions items based on identifying the trend across the multiple organizations.
